(19) United States
(12) Patent Application Publication
(10) Pub. No.: US 2022/0177638 A1
(43) Pub. Date: Jun. 9, 2022

(54) METHODS FOR PRODUCING FLAME-RETARDANT PUR/PIR FOAM MATERIALS

(71) Applicant: Covestro Intellectual Property GmbH Co. KG, Leverkusen (DE)

(72) Inventors: Rolf Albach, Köln (DE); Stephan Schleiermacher, Pullheim (DE); Horst-Josef Schaefer, Dormagen (DE); Hans-Peter Huber, Köln (DE); Andre Neumann, Dormagen (DE); Nicole Welsch, Rösrath (DE); Catherine Loevenich, Bergisch Gladbach (DE)

(21) Appl. No.: 17/440,562

(22) PCT Filed: Mar. 30, 2020
(86) PCT No.: PCT/EP2020/058902

§ 371 Date: Sep. 17, 2021

(30) Foreign Application Priority Data
Apr. 5, 2019 (EP) 19167527.1

(51) Int. Cl. C08G 18/76; C08G 18/42; C08G 18/16; C08G 18/18; C08G 18/22; C08K 5/523; C08K 5/5357; C08J 9/00; C08J 9/12; C08J 9/14

(52) U.S. Cl. CPC C08G 18/7671; C08J 2375/06; C08G 18/4213; C08G 18/163; C08G 18/1816; C08G 18/225; C08K 5/523; C08K 5/5357; C08J 9/0038; C08J 9/127; C08J 9/125; C08J 9/141; C08J 2201/022; C08J 2203/182; C08J 2203/10; C08J 2203/14; C08G 18/4238

(57) ABSTRACT

The invention relates to flame-retardant polyurethane foam materials or polyurethane/polyisocyanurate foam materials (also referred to individually or collectively as “PUR/PIR foam materials” below) and to methods for producing PUR/PIR foam materials by reacting a reaction mixture containing A1 an isocyanate-reactive component, A2 a propellant, A3 a catalyst, A4 optionally an additive, and A5 a flame retardant with B an isocyanate component, wherein the production is carried out using an index of 80 to 600. The invention is characterized in that the flame retardant A5 contains (hydroxymethyl)phosphonate and optionally the dimer thereof as component A5.1.

### CROSS REFERENCE TO RELATED APPLICATIONS

This application is a U.S. national stage application, filed under 35 U.S.C. § 371, of International Application No. PCT/EP2020/058902, which was filed on Mar. 30, 2020, which claims priority to European Patent Application No. 19167527.1, which was filed on Apr. 5, 2019. The contents of each are hereby incorporated by reference into this specification.

### FIELD

The present invention relates to flame-retarded polyurethane foams or polyurethane/polyisocyanurate foams (hereinbelow referred to individually or in common as “PUR/PIR foams”) containing dibutyl hydroxymethylphosphonate and to processes for producing PUR/PIR foams.

### BACKGROUND

Like all organic polymers PUR/PIR foams are flammable, the large surface area per unit mass in foams further reinforcing this behavior. PUR/PIR foams are often used as insulation materials, for example as insulation in the construction industry. Endowment with flame retardancy through added flame retardants is therefore necessary in many applications of PUR/PIR foams.

Preferably employed flame retardants include halogen-containing compounds and nitrogen and phosphorus compounds. Compounds containing halogens and low-valence phosphorus compounds are typical representatives of flame retardants that suffocate flames. Higher-valence phosphorus compounds are designed to bring about a catalytic cleavage of the polyurethanes in order to form a solid, polyphosphate-containing charred surface. This intumescence layer protects the material from further combustion (G. W. Becker, D. Braun: Polyurethane. In: G. Oertel (Ed.), Kunststoff Handbuch, Munich, Carl Hanser Verlag, 1983, 2, 104-1-5).

However, one disadvantage of the halogen-containing representatives of these classes in particular is that they are persistent and relatively volatile and can therefore migrate out of the foam (J. C. Quagliano, V. M. Wittemberg, I. C. G. Garcia: Recent Advances on the Utilization of Nanoclays and Organophosphorus Compounds in Polyurethane Foams for Increasing Flame Retardancy. In: J. Njuguna (Ed.), Structural Nanocomposites, Engineering Materials, Berlin Heidelberg, Springer Verlag, 2013, 1, 249-258) and that the use thereof results in the formation of corrosive hydrohalic acid in the combustion process.

The increasing prevalence of organic halogen compounds which in some cases have health-hazardous effects in the environment has shifted interest to halogen-free alternatives, for example to halogen-free phosphate esters and phosphite esters (S. V. Levchik, E. D. Weil: A Review of Recent Progress in Phosphorus-based Flame Retardants, J. Fire Sci., 2006, 24, 345-364, M. M Velencoso et al. Angewandte Chemie Int. Ed. 2018, 57, 10450-10467) and to red phosphorus.

Most widespread are PUR and PIR foams that have been endowed with flame retardancy with organic phosphates such as tris(2-chlorisopropyl) phosphate (TCPP) and triethyl phosphate (TEP). Organic phosphonate esters such as dimethylpropanephosphonate (DMPP, DE 44 18 307 A1) or diethylethylphosphonate (DEEP, U.S. Pat. No. 5,268,393) and others (WO 2006/108833 A1 and EP 1 142 940 A2) have also been described as halogen-free flame retardants for isocyanate-based rigid foams. The use of solid ammonium polyphosphate (APP) as a flame retardant is likewise prior art (US 2014/066532 A1 and U.S. Pat. No. 5,470,891); formulations based thereupon are not storage-stable due to APP's propensity for sedimentation.

But these halogen-free alternatives also have disadvantages: They are in some cases sensitive to hydrolysis under the alkaline conditions typical for PUR/PIR foam systems or show inadequate effectiveness. TEP is a powerful plasticizer and at the amounts required for a sufficient flame retardant effect often results in insufficient compressive strength of foams. Red phosphorus has disadvantages for example in respect of rapid absorption of moisture and rapid oxidation which leads to a loss of flame retardancy and possibly formation of toxic phosphines and also has a propensity for powder explosions. Red phosphorus is often microencapsulated to overcome these problems. (L. Chen, Y.-Z. Wang: A review on flame retardant technology in China. Part 1: development of flame retardants, Polym. Adv. Technol., 2010, 21, 1-26).

U.S. Pat. No. 3,385,801 and WO 2010/080425 discloses the preparation of dialkyl α-hydroxyalkylphosphonates and the use thereof as flame retardants. Nothing is disclosed about any effect of the dialkyl α-hydroxyalkylphosphonates on mechanical properties, especially elasticity and toughness in case of tensile load on polyurethane foams.

### SUMMARY

The present invention has for its object to allow the production of PUR/PIR foams with halogen-free flame retardants, wherein the PUR/PIR foams exhibit good flame retardancy and improved mechanical properties, wherein preferably no substances classified as carcinogenic, mutagenic or reprotoxic are employed.

This object was achieved by the inventive use of a component A5.1 as a flame retardant in the production of PUR/PIR foams.

The present invention provides a process for production of PUR/PIR foams by reaction of a reaction mixture containing
A1 an isocyanate-reactive component
A2 blowing agent
A3 catalyst
A4 optionally additive
A5 flame retardant
with
B an isocyanate component,
   wherein production is carried out at an index of 80 to 600,
   characterized in that the flame retardant A5 contains as component A5.1 dibutyl hydroxymethylphosphonate and optionally its dimer.

It has surprisingly been found that the PUR/PIR foams according to the invention containing a component A5.1 exhibit good flame retardancy despite low phosphorus contents. In a particular embodiment the kinetic properties of the formulations according to the invention for producing PUR/PIR foams are likewise improved. In a further particular embodiment the mechanical properties such as tensile strength, breaking elongation, toughness and open-cell content of the PUR/PIR foams are likewise improved.

### DETAILED DESCRIPTION

Employed as the isocyanate-reactive component A1 is at least one compound selected from the group consisting of polyether polyols, polyester polyols, polyether ester polyols, polycarbonate polyols and polyether-polycarbonate polyols. Polyester polyols and/or polyether polyols are preferred. The isocyanate-reactive component A1 can preferably have a hydroxyl number between 25 to 800 mg KOH/g, in particular 50 to 500 mg KOH/g, particularly preferably 100 to 400 mg KOH/g and very particularly preferably 100 to 300 mg KOH/g. The individual polyol component preferably has a number-average molecular weight of 120 g/mol to 6000 g/mol, in particular 400 g/mol to 2000 g/mol and particularly preferably 400 g/mol to 700 g/mol.

In the context of the present invention the number-average molar mass Mₙ (also known as molecular weight) is determined by gel permeation chromatography according to DIN 55672-1 (August 2007).

In the case of a single added polyol the OH number (also known as hydroxyl number) specifies the OH number of said polyol. Reported OH numbers for mixtures relate to the number-average OH number of the mixture calculated from the OH numbers of the individual components in their respective molar proportions. The OH number indicates the amount of potassium hydroxide in milligrams which is equivalent to the amount of acetic acid bound by one gram of substance during acetylation. In the context of the present invention the OH number is determined according to the standard DIN 53240-1 (June 2013).

Within the context of the present invention, “functionality” refers to the theoretical average functionality (number of isocyanate-reactive or polyol-reactive functions in the molecule) calculated from the known feedstocks and quantitative ratios thereof.

The equivalent weight specifies the ratio of the number-average molecular mass and the functionality of the isocyanate-reactive component. The reported equivalent weights for mixtures are calculated from equivalent weights of the individual components in their respective molar proportions and relate to the number-average equivalent weight of the mixture.

The polyester polyols of component A1 may be for example polycondensates of polyhydric alcohols, preferably diols, having 2 to 12 carbon atoms, preferably having 2 to 6 carbon atoms, and polycarboxylic acids, for example di-, tri- or even tetracarboxylic acids or hydroxycarboxylic acids or lactones, and it is preferable to employ aromatic dicarboxylic acids or mixtures of aromatic and aliphatic dicarboxylic acids. Also employable for preparing the polyesters instead of the free polycarboxylic acids are the corresponding polycarboxylic anhydrides or corresponding polycarboxylic esters of lower alcohols. It is preferable to use phthalic anhydride, terephthalic acid and/or isophthalic acid.

Contemplated carboxylic acids especially include: succinic acid, glutaric acid, adipic acid, suberic acid, azelaic acid, sebacic acid, decanedicarboxylic acid, tetrahydrophthalic acid, hexahydrophthalic acid, cyclohexanedicarboxylic acid, tetrachlorophthalic acid, itaconic acid, malonic acid, furandicarboxylic acids, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid, trimellitic acid, benzoic acid, trimellitic acid, maleic acid, fumaric acid, phthalic acid, isophthalic acid and terephthalic acid. It is likewise possible to use derivatives of these carboxylic acids, for example dimethyl terephthalate. The carboxylic acids may be used both singly and in admixture. Preferably employed as carboxylic acids are adipic acid, sebacic acid and/or succinic acid, particularly preferably adipic acid and/or succinic acid.

Hydroxycarboxylic acids that may be co-employed as reaction participants in the preparation of a polyester polyol having terminal hydroxyl groups are for example hydroxycaproic acid, hydroxybutyric acid, hydroxydecanoic acid, hydroxystearic acid and the like. Suitable lactones are inter alia caprolactone, propiolactone butyrolactone and homologs.

Also especially useful for preparation of the polyester polyols are bio-based starting materials and/or derivatives thereof, for example castor oil, polyhydroxy fatty acids, ricinoleic acid, hydroxyl-modified oils, grapeseed oil, black cumin oil, pumpkin seed oil, borage seed oil, soybean oil, wheat germ oil, rapeseed oil, sunflower seed oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, fatty acids, hydroxyl-modified and epoxidized fatty acids and fatty acid esters, for example based on myristoleic acid, palmitoleic acid, oleic acid, vaccenic acid, petroselic acid, gadoleic acid, erucic acid, nervonic acid, linoleic acid, alpha- and gamma-linolenic acid, stearidonic acid, arachidonic acid, timnodonic acid, clupanodonic acid and cervonic acid. Esters of ricinoleic acid with polyfunctional alcohols, for example glycerol, are especially preferred. Preference is also given to the use of mixtures of such bio-based acids with other carboxylic acids, for example phthalic acids.

Examples of suitable diols are ethylene glycol, butylene glycol, diethylene glycol, triethylene glycol, polyalkylene glycols such as polyethylene glycol, and also 1,2-propanediol, 1,3-propanediol, cyclohexanedimethanol, 1,3-butanediol, 1,4-butanediol, 1,6-hexanediol and isomers, neopentyl glycol or neopentyl glycol hydroxypivalate. Preference is given to using ethylene glycol, diethylene glycol, butane-1,4-diol, pentane-1,5-diol, hexane-1,6-diol or mixtures of at least two of the diols mentioned, in particular mixtures of butane-1,4-diol, pentane-1,5-diol and hexane-1,6-diol.

It is additionally also possible to use polyols such as trimethylolpropane, glycerol, erythritol, pentaerythritol, trimethylolbenzene or trishydroxyethyl isocyanurate, wherein glycerol and trimethylolpropane are preferred.

In addition, monohydric alkanols can additionally also be co-used.

Polyether polyols used according to the invention are obtained by preparation methods known to those skilled in the art, such as for example by anionic polymerization of one or more alkylene oxides having 2 to 4 carbon atoms with alkali metal hydroxides, such as sodium or potassium hydroxide, alkali metal alkoxides, such as sodium methoxide, sodium or potassium ethoxide or potassium isopropoxide, or aminic alkoxylation catalysts, such as dimethylethanolamine (DMEOA), imidazole and/or imidazole derivatives, using at least one starter molecule containing 2 to 8, preferably 2 to 6, reactive hydrogen atoms in bonded form.

Suitable alkylene oxides are for example tetrahydrofuran, 1,3-propylene oxide, 1,2- and 2,3-butylene oxide, styrene oxide and preferably ethylene oxide and 1,2-propylene oxide. The alkylene oxides may be used singly, alternately in succession or as mixtures. Preferred alkylene oxides are propylene oxide and ethylene oxide and ethylene oxide is particularly preferred. The alkylene oxides may be reacted in combination with CO₂.

Contemplated starter molecules include for example: water, organic dicarboxylic acids, such as succinic acid, adipic acid, phthalic acid and terephthalic acid, aliphatic and aromatic, optionally N-mono-, N,N- and N,N′-dialkyl-substituted diamines having 1 to 4 carbon atoms in the alkyl radical, such as optionally mono- and dialkyl-substituted ethylenediamine, diethylenetriamine, triethylenetetramine, 1,3-propylenediamine, 1,3- and 1,4-butylenediamine, 1,2-, 1,3-, 1,4-, 1,5- and 1,6-hexamethylenediamine, phenylenediamines, 2,3-, 2,4- and 2,6-tolylenediamine and 2,2′-, 2,4′- and 4,4′-diaminodiphenylmethane.

Preference is given to using dihydric or polyhydric alcohols such as ethanediol, propane-1,2- and -1,3-diol, diethylene glycol, dipropylene glycol, butane-1,4-diol, hexane-1,6-diol, triethanolamine, bisphenols, glycerol, trimethylolpropane, pentaerythritol, sorbitol and sucrose.

Polycarbonate polyols that may be used are polycarbonates having hydroxyl groups, for example polycarbonate diols. These are formed in the reaction of carbonic acid derivatives, such as diphenyl carbonate, dimethyl carbonate or phosgene, with polyols, preferably diols.

Examples of such diols are ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenols, and lactone-modified diols of the abovementioned type.

Also employable instead of or in addition to pure polycarbonate diols are polyether polycarbonate diols obtainable for example by copolymerization of alkylene oxides, such as for example propylene oxide, with CO₂.

Employable polyether ester polyols are compounds containing ether groups, ester groups and OH groups. Organic dicarboxylic acids having up to 12 carbon atoms are suitable for preparing the polyether ester polyols, preferably aliphatic dicarboxylic acids having 4 to 6 carbon atoms or aromatic dicarboxylic acids used singly or in admixture. Examples include suberic acid, azelaic acid, decanedicarboxylic acid, furandicarboxylic acid, maleic acid, malonic acid, phthalic acid, pimelic acid and sebacic acid and in particular glutaric acid, fumaric acid, succinic acid, adipic acid, phthalic acid, terephthalic acid and isoterephthalic acid. In addition to organic dicarboxylic acids, derivatives of these acids can also be used, for example their anhydrides and also their esters and half-esters with low molecular weight monofunctional alcohols having 1 to 4 carbon atoms. The use of proportions of the abovementioned bio-based starting materials, in particular of fatty acids/fatty acid derivatives (oleic acid, soybean oil etc.), is likewise possible and can have advantages, for example in respect of storage stability of the polyol formulation, dimensional stability, fire behavior and compressive strength of the foams.

Polyether polyols obtained by alkoxylation of starter molecules such as polyhydric alcohols are a further component used for producing the polyether ester polyols. The starter molecules are at least difunctional, but may optionally also contain proportions of higher-functional, in particular trifunctional, starter molecules.

Starter molecules include for example diols such as 1,2-ethanediol, 1,3-propanediol, 1,2-propanediol, 1,4-butanediol, 1,5-pentenediol, 1,5-pentanediol, neopentyl glycol, 1,6-hexanediol, 1,7-heptanediol, 1,8-octanediol, 1,10-decanediol, 2-methyl-1,3-propanediol, 2,2-dimethyl-1,3-propanediol, 3-methyl-1,5-pentanediol, 2-butyl-2-ethyl-1,3-propanediol, 2-butene-1,4-diol and 2-butyne-1,4-diol, ether diols such as diethylene glycol, triethylene glycol, tetraethylene glycol, dibutylene glycol, tributylene glycol, tetrabutylene glycol, dihexylene glycol, trihexylene glycol, tetrahexylene glycol and oligomeric mixtures of alkylene glycols, such as diethylene glycol. Starter molecules having functionalities other than OH can also be used alone or in a mixture.

In addition to the diols, starter molecules used for preparing the polyethers may also be compounds having more than 2 Zerewitinoff-active hydrogens, particularly having number-average functionalities of 3 to 8, in particular of 3 to 6, for example 1,1,1-trimethylolpropane, triethanolamine, glycerol, sorbitan and pentaerythritol and also triol- or tetraol-started polyethylene oxide polyols.

Polyether ester polyols may also be prepared by the alkoxylation, in particular by ethoxylation and/or propoxylation, of reaction products obtained by the reaction of organic dicarboxylic acids and their derivatives and components with Zerewitinoff-active hydrogens, in particular diols and polyols. Derivatives of these acids that may be employed include for example their anhydrides, for example phthalic anhydride.

Processes for preparing the polyols have been described for example by Ionescu in “Chemistry and Technology of Polyols for Polyurethanes”, Rapra Technology Limited, Shawbury 2005, p. 55 et seq. (chapt. 4: Oligo-Polyols for Elastic Polyurethanes), p. 263 et seq. (chapt. 8: Polyester Polyols for Elastic Polyurethanes) and in particular on p. 321 et seq. (chapt. 13: Polyether Polyols for Rigid Polyurethane Foams) and p. 419 et seq. (chapt. 16: Polyester Polyols for Rigid Polyurethane Foams). It is also possible to obtain polyester polyols and polyether polyols by glycolysis of suitable polymer recyclates. Suitable polyether polycarbonate polyols and the preparation thereof are described, for example, in EP 2 910 585 A1, [0024]-[0041]. Examples of polycarbonate polyols and the preparation thereof can be found, inter alia, in EP 1 359 177 A1. The preparation of suitable polyetherester polyols has been described, inter alia, in WO 2010/043624 A and in EP 1 923 417 A.

The isocyanate-reactive component A1 may further contain low molecular weight isocyanate-reactive compounds, by preference di- or trifunctional amines and alcohols, preferably diols and/or triols having molar masses M. of less than 400 g/mol, in particular of 60 to 300 g/mol, for example triethanolamine, diethylene glycol, ethylene glycol and glycerol, may be employed. Provided such low molecular weight isocyanate-reactive compounds are used for producing the rigid polyurethane foams, for example as chain extenders and/or crosslinking agents, these are advantageously employed in an amount of up to 5% by weight based on the total weight of component A1.

In addition to the above-described polyols and isocyanate-reactive compounds the component A1 may contain further isocyanate-reactive compounds, for example graft polyols, polyamines, polyamino alcohols and polythiols. It will be appreciated that the described isocyanate-reactive components also comprise compounds having mixed functionalities.

The component A1 may consist of one or more of the abovementioned isocyanate-reactive components.

Employable blowing agents A2 include physical blowing agents such as for example low-boiling organic compounds, for example, hydrocarbons, halogenated hydrocarbons, ethers, ketones, carboxylic esters or carbonic esters. Organic compounds inert towards the isocyanate component B and having boiling points below 100° C., preferably below 50° C., at atmospheric pressure are suitable in particular. These boiling points have the advantage that the organic compounds evaporate under the influence of the exothermic polyaddition reaction. Examples of such preferably used organic compounds are alkanes, such as heptane, hexane, n-pentane and isopentane, preferably technical grade mixtures of n-pentane and isopentane, n-butane and isobutane and propane, cycloalkanes, such as for example cyclopentane and/or cyclohexane, ethers, such as for example furan, dimethyl ether and diethyl ether, ketones, such as for example acetone and methyl ethyl ketone, alkyl carboxylates, such as for example methyl formate, dimethyl oxalate and ethyl acetate and halogenated hydrocarbons, such as for example methylene chloride, dichloromonofluoromethane, difluoromethane, trifluoromethane, difluoroethane, tetrafluoroethane, chlorodifluoroethanes, 1,1-dichloro-2,2,2-trifluoroethane, 2,2-dichloro-2-fluoroethane and heptafluoropropane. Also preferred is the use of (hydro)fluorinated olefins, for example HFO 1233zd(E) (trans-1-chloro-3,3,3-trifluoro-1-propene) or HFO 1336mzz(Z) (cis-1,1,1,4,4,4-hexafluoro-2-butene) or additives such as FA 188 from 3M (1,1,1,2,3,4,5,5,5-nonafluoro-4-(trifluoromethyl)pent-2-ene). Mixtures of two or more of the recited organic compounds may also be employed. The organic compounds may also be used here in the form of an emulsion of small droplets.

Also employable as blowing agent A2 are chemical blowing agents, such as for example water, carboxylic acid and mixtures thereof. These react with isocyanate groups to form the blowing gas, forming carbon dioxide for example in the case of water and forming carbon dioxide and carbon monoxide for example in the case of formic acid. The carboxylic acid used is preferably at least one compound selected from the group consisting of formic acid, acetic acid, oxalic acid and ricinoleic acid. A particularly preferred chemical blowing agent is water.

Halogenated hydrocarbons are preferably not used as blowing agent.

At least one compound selected from the group consisting of physical and chemical blowing agents is employed as blowing agent A2. Preference is given to using only physical blowing agent. In a preferred embodiment, the blowing agents A2 used have a mean global warming potential (GWP) of <120, preferably a GWP of <20.

Employed as catalysts A3 for producing the PUR/PIR foams are compounds which accelerate the reaction of the compounds containing reactive hydrogen atoms, in particular hydroxyl groups, with the isocyanate component B, such as for example tertiary amines or metal salts. The catalyst components may be metered into the reaction mixture or else completely or partially initially charged in the isocyanate-reactive component A1.

Compounds employed are for example tertiary amines, such as triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)urea, N-methyl- or N-ethylmorpholine, N-cyclohexylmorpholine, N,N,N′,N′-tetramethylethylenediamine, N,N,N,N-tetramethylbutanediamine, N,N,N,N-tetramethylhexane-1,6-diamine, pentamethyldiethylenetriamine, bis[2-(dimethylamino)ethyl] ether, dimethylpiperazine, N-dimethylaminoethylpiperidine, 1,2-dimethylimidazole, 1-azabicyclo[3,3,0]octane, 1,4-diazabicyclo[2,2,2]octane (Dabco) and alkanolamine compounds such as triethanolamine, triisopropanolamine, N-methyl- and N-ethyldiethanolamine, dimethylaminoethanol, 2-(N,N-dimethylaminoethoxy)ethanol, N,N′,N″-tris(dialkylaminoalkyl)hexahydrotriazine, for example N,N′,N″-tris(dimethylaminopropyl)hexahydrotriazine and triethylenediamine.

Metal salts, for example alkali metal or transition metal salts, may also be used. Transition metal salts used are for example zinc salts, bismuth salts, iron salts, lead salts or preferably tin salts. Examples of transition metal salts used are iron(II) chloride, zinc chloride, lead octoate, tin dioctoate, tin diethylhexoate and dibutyltin dilaurate. The transition metal salt is particularly preferably selected from at least one compound from the group consisting of tin dioctoate, tin diethylhexoate and dibutyltin dilaurate. Examples of alkali metal salts are alkali metal alkoxides such as for example sodium methoxide and potassium isopropoxide, alkali metal carboxylates such as for example potassium acetate, and also alkali metal salts of long-chain fatty acids having 10 to 20 carbon atoms and optionally pendant OH groups. It is preferable to employ one or more alkali metal carboxylates as the alkali metal salt.

Contemplated catalysts A3 further include: amidines, for example 2,3-dimethyl-3,4,5,6-tetrahydropyrimidine, tetraalkylammonium hydroxides, for example tetramethylammonium hydroxide, alkali metal hydroxides, for example sodium hydroxide, and tetraalkylammonium carboxylates or phosphonium carboxylates Mannich bases and salts of phenols are also suitable catalysts. It is also possible to perform the reactions without catalysis. In this case the catalytic activity of amine-started polyols is utilized.

If a relatively large polyisocyanate excess is used when foaming contemplated catalysts for the trimerization reaction of the excess NCO groups with one another further include: isocyanurate group-forming catalysts, for example ammonium ion salts or alkali metal salts, especially ammonium carboxylates or alkali metal carboxylates, alone or in combination with tertiary amines. The isocyanurate formation results in particularly flame-retardant PIR foams.

The abovementioned catalysts may be used alone or in combination with one another.

One or more additives may optionally be used as component A4. Examples of component A4 are surface-active substances, foam stabilizers, cell regulators, fillers, dyes, pigments, hydrolysis stabilizers, fungistatic and bacteriostatic substances.

Contemplated surface-active substances include for example compounds that serve to promote the homogenization of the starting substances and are optionally also suitable for regulating the cell structure of the plastics. Examples include emulsifiers, such as the sodium salts of castor oil sulfates or of fatty acids and salts of fatty acids with amines, for example diethylamine oleate, diethanolamine stearate, diethanolamine ricinoleate, salts of sulfonic acids, for example alkali metal or ammonium salts of dodecylbenzenedisulfonic acid or dinaphthylmethanedisulfonic acid and ricinoleic acid; foam stabilizers, such as siloxane oxyalkylene mixed polymers and other organopolysiloxanes, ethoxylated alkylphenols, ethoxylated fatty alcohols, paraffin oils, castor oil esters or ricinoleic esters, Turkey red oil and peanut oil, and cell regulators, such as paraffins, fatty alcohols and dimethylpolysiloxanes. The above-described oligomeric acrylates having polyoxyalkylene and fluoroalkane radicals as side groups are also suitable for improving emulsifying action, cell structure and/or stabilization of the foam.

Fillers, in particular reinforcing fillers, include the customary organic and inorganic fillers, reinforcers, weighting agents, agents for improving abrasion characteristics in paints, coating agents etc. which are known per se. These especially include for example: inorganic fillers such as siliceous minerals, for example phyllosilicates such as for example antigorite, serpentine, sepiolite, hornblendes, amphiboles, chrysotile, montmorillonite and talc, metal oxides such as kaolin, aluminum oxides, titanium oxides and iron oxides, metal salts, such as chalk, huntite, barite and inorganic pigments, such as magenetite, goethite, cadmium sulfide and zinc sulfide and also glass inter alia, and natural and synthetic fibrous minerals such as wollastonite, metal fibers and in particular glass fibers of various lengths which may optionally have been coated with a size. Examples of contemplated organic fillers include: carbon, melamine, colophony, cyclopentadienyl resins and graft polymers and also cellulose fibers, polyamide fibers, polyacrylonitrile fibers, polyurethane fibers and polyester fibers based on aromatic and/or aliphatic dicarboxylic esters and carbon fibers.

To produce the PUR/PIR foams a flame retardant A5 is employed, wherein according to the invention the flame retardant A5 contains as component A5.1 dibutyl hydroxymethylphosphonate and optionally its dimer. Preparation of the compounds of component A5.1 is known per se and described for example in WO 2010/080425. Preparation is generally carried out in the presence of a catalyst and may be carried out solventlessly or in the presence of a solvent.

Preparation of the compounds of component A5.1 is preferably carried out using a catalyst selected from the group consisting of phosphorus-containing bases, such as phosphazenes or alkali metal phosphates, alkali metal carbonates and amines, with the exception of tertiary trialkylamines, particularly preferably selected from the group consisting of phosphorus-containing bases and alkali metal carbonates. It is particularly preferable to employ a phosphorus-containing base as catalyst. It is preferable to employ sodium or potassium as the alkali metal for the alkali metal phosphates and alkali metal carbonates.

It is also preferable to prepare the component A5.1 without solvent or in a phosphorus-containing solvent (for example hydroxymethylphosphonate).

If the dimer of dibutyl hydroxymethylphosphonate is present in the component A5.1 the dimer of dibutyl hydroxymethyl phosphonate is preferably present in a proportion of 0.1% to 30.0% by weight, particularly preferably 1.0% to 25.0% by weight, very particularly preferably 4.0% to 15.0% by weight, based on the total weight of the dibutyl hydroxymethylphosphonate.

In addition to the component A5.1 the flame retardant A5 may further flame retardants such as for example phosphates, for example triethyl phosphate (TEP), triphenyl phosphate (TPP), tricresyl phosphate, diphenyl cresyl phosphate (DPK), tert-butylphenyldiphenyl phosphate, resorcinyl diphenyl phosphate (also as oligomer) and bisphenol A bis(diphenyl phosphate) (also as oligomer). Phosphonates such as diethyl ethylphosphonate (DEEP), dimethyl propylphosphonate (DMPP), diethyl diethanolaminomethylphosphonate, Veriquel® R100 or “E06-16” from ICL, and also mixed phosphonates such as ethylbutylhydroxymethylphosphonate and phosphinates such as 9,10-dihydro-9-oxa-10-phosphorylphenanthrene 10-oxide (DOPO), salts of diphenylphosphinous acid and salts of diethylphosphinic acid Et₂PO₂H (Exolit® OP 1235, Exolit® OP 935, Exolit® OP 935, Exolit® OP L 1030) are employed. Further suitable flame retardants A5 include for example brominated esters, brominated ethers (Ixol) or brominated alcohols such as dibromoneopentyl alcohol, tribromoneopentyl alcohol, tetrabromophthalate diol, and also chlorinated phosphates such as tris(2-chloroethyl) phosphate, tris(2-chloropropyl) phosphate (TCPP), tris(1,3-dichloropropyl) phosphate, tris(2,3-dibromopropyl) phosphate, tetrakis(2-chloroethyl) ethylenediphosphate and also commercially available halogen-containing flame-retardant polyols. Diphenyl cresyl phosphate, triethyl phosphate and bisphenol A bis(diphenyl phosphate) are preferred. It is particularly preferable when no halogen-containing flame retardant is employed.

The proportion of the component A5.1 in the flame retardant A5 is preferably 30.0% by weight to 100.0% by weight, preferably 50.0 to 100.0% by weight, in particular 80.0 to 100.0% by weight, in each case based on the total mass of the flame retardant A5.

The proportion of component A5.1 in the reaction mixture is preferably 0.1% by weight to 30.0% by weight, preferably 5.0% by weight to 25.0% by weight, in particular 10.0 to 25.0% by weight, in each case based on the total mass of the component A1=100% by weight.

Contemplated suitable isocyanate components B are for example polyisocyanates, i.e. isocyanates having an NCO functionality of at least 2. Examples of such suitable polyisocyanates include 1,4-butylene diisocyanate, 1,5-pentanediisocyanate, 1,6-hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI) and also alkyl 2,6-diisocyanatohexanoates (lysine diisocyanates) having C1- to C6-alkyl groups. The isocyanate component B is preferably selected from at least one compound from the group consisting of MDI, polymeric MDI and TDI.

In addition to the abovementioned polyisocyanates, it is also possible to co-use proportions of modified diisocyanates having a uretdione, isocyanurate, urethane, carbodiimide, uretonimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

Also employable as the isocyanate component B instead of or in addition to the abovementioned polyisocyanates are suitable NCO prepolymers. The prepolymers are preparable by reaction of one or more polyisocyanates with one or more polyols corresponding to the polyols described under the isocyanate-reactive components A1.

The isocyanate index (also known as the index) is to be understood as meaning the quotient of the actually employed amount of substance [mol] of isocyanate groups and the actually employed amount of substance [mol] of isocyanate-reactive groups, multiplied by 100:

index=(moles of isocyanate groups/moles of isocyanate-reactive groups)*100

According to the invention the index in the reaction mixture is 80 to 600, by preference 100 to 500, preferably 200 to 400. This index is particularly preferably in a range from 240 to 400 in which a high proportion of polyisocyanurates (PIR) is present (the foam is referred to as a PIR foam or PUR/PIR foam) and results in a higher flame retardancy of the PUR/PIR foam itself. Another particularly preferred range for the isocyanate index is the value range from 90 to 150, in particular from 110 to 150, (the foam is referred to as a polyurethane foam (PUR foam)) in which the PUR/PIR foam tends to have a reduced brittleness for example.

The NCO value (also known as NCO content, isocyanate content) is determined according to EN ISO 11909 (May 2007). The values are at 25° C. unless stated otherwise.

The invention likewise relates to a PUR/PIR foam produced by the process according to the invention.

The PUR/PIR foams according to the invention are produced by one-step processes known to those skilled in the art and in which the reaction components are continuously or discontinuously reacted with one another and then subsequently introduced either manually or with the aid of mechanical equipment in the high-pressure or low-pressure process after discharge onto a conveyor belt or into suitable molds for curing. Examples are described in U.S. Pat. No. 2,764,565, in G. Oertel (ed.) “Kunststoff-Handbuch”, Volume VII, Carl Hanser Verlag, 3rd edition, Munich 1993, pages 267 ff., and in K. Uhlig (ed.) “Polyurethan Taschenbuch”, Carl Hanser Verlag, 2nd edition, Vienna 2001, pages 83-102.

The PUR/PIR foams according to the invention are preferably used for the production of composite elements. Foaming is typically carried out here in continuous or discontinuous fashion against at least one outer layer.

The invention accordingly further provides for the use of a PUR/PIR foam according to the invention as an insulation foam and/or as an adhesion promoter in composite elements, wherein the composite elements comprise a layer comprising a PUR/PIR foam according to the invention and at least one outer layer. The outer layer is in this case at least partially contacted by a layer comprising the PUR/PIR foam according to the invention. Composite elements of the type of interest here are also known as sandwich elements or insulation panels and are generally used as building elements for soundproofing, insulation, for commercial buildings or for façade construction. The outer layers may be formed for example by sheets of metal, sheets of plastics or particleboards of up to 7 mm in thickness depending on the application of the composite elements. The one or two outer layers may in each case be a flexible outer layer, for example made of an aluminum foil, paper, multilayer outer layers made of paper and aluminum or of mineral nonwovens and/or a rigid outer layer, for example made of sheet steel or particleboard.

In a first embodiment the invention relates to a process for production of PUR/PIR foams by reaction of a reaction mixture containing
A1 an isocyanate-reactive component
A2 blowing agent
A3 catalyst
A4 optionally additive
A5 flame retardant
with
B an isocyanate component,
   wherein production is carried out at an index of 80 to 600,
   characterized in that the flame retardant A5 contains as component A5.1 dibutyl hydroxymethylphosphonate and optionally its dimer.

In a second embodiment the invention relates to a process according to the first embodiment, characterized in that the isocyanate-reactive component A1 contains a polyester polyol.

In a third embodiment the invention relates to a process according to the second embodiment, characterized in that the polyester polyol has an OH number in the range from 100 to 400 mg KOH/g.

In a fourth embodiment the invention relates to a process according to any of embodiments 1 to 3, characterized in that the blowing agent A2 is selected from one or more compounds from the group consisting of halogen-free chemical blowing agents, halogen-free physical blowing agents and (hydro)fluorinated olefins.

In a fifth embodiment the invention relates to a process according to any of the embodiments 1 to 4, characterized in that the flame retardant A5 contains 30.0% by weight to 100.0% by weight, based on the total mass of the flame retardant A5, of the component A5.1.

In a sixth embodiment the invention relates to a process according to any of embodiments 1 to 5, characterized in that the proportion of component A5.1 is 0.1% by weight to 30.0% by weight based on the total mass of the component A1=100% by weight and preferably 0.04-0.4 mol of phosphonate per kg of foam.

In a seventh embodiment the invention relates to a process according to any of embodiments 1 to 6, characterized in that the flame retardant A5 contains no halogen-containing flame retardant.

In an eighth embodiment the invention relates to a process according to any of embodiments 1 to 7, characterized in that the component A5.1 has been produced using a catalyst selected from at least one compound from the group consisting of phosphorus-containing bases, alkali metal carbonates and amines, with the exception of tertiary trialkylamines.

In a ninth embodiment the invention relates to a process according to any of claims 1 to 7, characterized in that the component A5.1 has been produced using a phosphorus-containing base as catalyst.

In a tenth embodiment the invention relates to a process according to any of claims 1 to 7, characterized in that the component A5.1 has been produced in the absence of tertiary amines and without phosphorus-free solvents.

In an eleventh embodiment the invention relates to a process according to any of embodiments 1 to 10, characterized in that the component A5.1 is a mixture of dibutyl hydroxymethylphosphonate and 0.1% to 30% by weight, based on the total weight of the employed dibutylhydroxymethylphosphonate, of the dimer of dibutyl hydroxymethylphosphonate.

In a twelfth embodiment the invention relates to a process according to the first embodiment, characterized in that the reaction mixture containing
A1 50% by weight to 100% by weight of one or more polyester polyols and 0% by weight to 20% by weight of one or more polyether polyols, in each case based on the total weight of the component A1,
A2 water and physical blowing agents,
A3 catalyst,
A4 optionally additive,
A5 flame retardant containing A5.1 dibutyl hydroxymethylphosphonate and optionally its dimer,
is reacted with
B polymeric isocyanate.

In a thirteenth embodiment the invention relates to a process according to the first embodiment, characterized in that a reaction mixture containing
A1 a polyester polyol having a hydroxyl number of 50 mg KOH/g to 400 mg KOH/g,
A2 blowing agent containing a compound selected from the group consisting of halogen-free chemical blowing agents, halogen-free physical blowing agents and (hydro)fluorinated olefins,
A3 catalyst containing alkali metal carboxylate and/or di- or trialkylaminomethylphenol,
A4 additive containing a foam stabilizer,
A5 flame retardant containing A5.1 dibutylhydroxymethylphosphonate and optionally its dimer,
with
B monomeric and polymeric MDI.

In a fourteenth embodiment the invention relates to a PUR/PIR foam obtainable by the process according to any of embodiments 1 to 13.

In a fifteenth embodiment the invention relates to the use of PUR/PIR foams according to the fourteenth embodiment for producing an insulation material.

In a sixteenth embodiment the invention relates to a process according to any of embodiments 1 to 13, characterized in that production is carried out at an index of 110 to 150.

In a seventeenth embodiment the invention relates to a process according to any of embodiments 1 to 13, characterized in that production is carried out at an index of 240 to 390.

### Examples

The OH number (hydroxyl number) was determined according to DIN 53240-1 (June 2013). The acid number was determined according to DIN EN ISO 2114 (November 2006). Viscosity was determined on an Anton Paar Physica MCR 501 rheometer. A cone-plate configuration having a separation of 1 mm was selected (DCP25 measurement system). The polyol (0.1 g) was applied to the rheometer plate and subjected to a shear of 0.01 to 1000 1/s at 25° C. and the viscosity was measured every 10 s for 10 min. What is reported is the viscosity averaged over all measurement points.

Diethyl hydroxymethylphosphonate (DEHMP) and dibutyl hydroxymethylphosphonate (DBHMP) are identified using proton-decoupled ³¹P-NMR spectroscopy by means of their signals at 23.8 and 23.7 ppm (H₃PO₄=0.0 ppm). The dimers are identified via two doublets each (J_{P-P}=59 Hz) at 17.8 and 25.2 ppm for DEHMP and 18.2 and 25.3 ppm for DBHMP. The 0-acetylated derivatives are identifiable by their ³¹P signals at 17.85 ppm (acetylated DEHMP) and 18.0 ppm (acetylated DBHMP) and doublets at 16.7 and 19.7 ppm (dimers of acetylated DEHMP) and doublets at 16.9 and 19.8 ppm (dimers of acetylated DBHMP). Reported hereinbelow is an indicator D/M that indicates the ³¹P-NMR integrals of the doublet associated with the dimer in the range from 16.5-18.5 ppm relative to the monomer. Conversion of the indicator D/M to a weight ratio of monomer to dimer is carried out assuming equal relaxation times of all phosphorus atoms in the ³¹P-NMR and neglecting any superimposed trace impurities

### Input Materials:

A1-1 86% by weight of an aliphatic polyester polyol having an OH number of 214 mg KOH/g and a viscosity of 2000 mPas at 25° C. produced by reacting a mixture of adipic acid, succinic acid and glutaric acid with ethylene glycol,
   14% by weight of an aliphatic polyether polyol having an OH number of 28, 90 mol % of primary OH groups and a viscosity of 860 mPas at 25° C. (Desmophen® L 2830, Covestro Deutschland AG)
A1-2 93% by weight of a polyester polyol based on terephthalic acid, adipic acid and diethylene glycol having an OH number of 195 mg KOH/g,
   7% by weight of a polyether polyol having a central block of propylene oxide and two terminal blocks of ethylene oxide
A1-3 100% by weight of an aromatic polyester polyol having an OH number of 240 mg KOH/g (Stepanpol® PS-2352, Stepan Company)
A2-1 n-Pentane
A2-2 Water
A2-3 Mixture of cyclopentane and isopentane in a weight ratio of 30/70
A3-1 Dimethylcyclohexylamine
A3-2 25% by weight potassium acetate in diethylene glycol
A4-1 Polyether-modified silicone (Tegostab® B8421, Evonik)
A5-1 Tris(2-chlorisopropyl)phosphate (Levagard® PP, Lanxess)
A5-2 Diphenyl cresyl phosphate (Disflamoll® DPK, Lanxess)
A5-3 Cyclic phosphonate having a phosphorus content of 19% by weight (Aflammit® PLF 710, Thor GmbH)
B-1 polymeric MDI having a viscosity of 700 mPas at 25° C. and an NCO content of 31.5% by weight (Desmodur® 44V70L, Covestro Deutschland AG)

### A5-4: Preparation of Diethyl Hydroxymethylphosphonate (DEHMP)

138.1 g of diethyl phosphite (1 mol), 36.04 g of paraformaldehyde (1.2 mol), 0.2 dm³ of isobutanol, 0.15 dm³ of cyclopentane and 6.9 g of potassium carbonate (50 mmol, 5 mol %) are mixed at 35° C. and with stirring in a 1 dm³ four-necked flask fitted with a reflux condenser, nitrogen blanket and thermometer heated to reflux for one hour. After cooling and filtering the solvents are removed from the mixture on a rotary evaporator at 60° C. down to a final vacuum of 10 mbar. A yield of 178.25 grams of a clear liquid remains. The OH number is 300 mg KOH/g, the acid number 5.83 mg KOH/g.

D/M=0.011

Calculated weight ratio of monomer to dimer=98:2

### A5-5: Preparation of Diethyl Hydroxymethylphosphonate (DEHMP)

138.1 g of diethyl phosphite (1 mol), 0.35 dm³ of 1-butanol and 36.04 g of paraformaldehyde (1.2 mol) were heated to 35° C. with stirring in a 0.5 dm³ four-necked flask fitted with a reflux condenser, nitrogen blanket and thermometer. 6.9 grams of dry potassium carbonate are added portionwise. The temperature is kept at ≤60° C. using a water bath. After the addition, the reaction mixture is stirred at 60° C. for a total of 1 hour. After cooling and filtering the solution and from the mixture is distilled on a rotary evaporator at temperatures from increasing to 60° C. over four hours down to a final vacuum of 10 mbar. A yield of 180 grams is obtained. D/M=0.009

Calculated weight ratio of monomer to dimer=98:2

A5.1-1: Preparation of Dibutyl Hydroxymethylphosphonate (DBHMP) with Potassium Phosphate as Catalyst

97.4 g of dibutyl phosphite (0.5 mol), 25.03 g of tributyl phosphite (0.1 mol) and 3.4 g of potassium phosphate K₃PO₄ (16 mmol, 1.6 mol %) are mixed and with stirring in a 0.5 dm³ four-necked flask fitted with a reflux condenser, nitrogen blanket and thermometer heated to 65° C. Simultaneously in a PE wash bottle with a magnetic stirrer at 20° C. 31.5 g of paraformaldehyde (1.05 mol) are stirred up in 58.2 g of dibutyl phosphite (0.3 mol). The suspension is metered into the four-necked flask in six portions. The temperature is kept at ≤75° C. using a water bath. After the sixth portion 19.4 g of dibutyl phosphite (0.1 mol) are filled into the wash bottle and the remaining paraformaldehyde adhering to the walls is washed into the four-necked flask. After the addition, the reaction mixture is stirred at 75° C. for a total of 4 hours. After cooling and the solution and from the mixture 9.0 grams of distillate is removed on a rotary evaporator at temperatures from 60° C. increasing to 75° C. over four hours down to a final vacuum of 10 mbar. A yield of 212.9 grams of a clear liquid remains. The OH number is 212 mg KOH/g, the acid number 0.5 mg KOH/g.

D/M=0.11

Calculated weight ratio of monomer to dimer=84:16

A5.1-2: Preparation of Butylethyl Hydroxymethylphosphonate with Potassium Phosphate as Catalyst

97.4 g of dibutyl phosphite (0.5 mol), 16.62 g of triethyl phosphite (0.1 mol) and 1.36 g of potassium phosphate K₃PO₄ (6.4 mmol, 0.64 mol %) are mixed and with stirring in a 0.5 dm³ four-necked flask fitted with a reflux condenser, nitrogen blanket and thermometer heated to 70° C. Simultaneously in a PE wash bottle with a magnetic stirrer at 20° C. 31.5 g of paraformaldehyde (1.05 mol) are stirred up in 58.2 g of dibutyl phosphite (0.3 mol). The suspension is metered into the four-necked flask in six portions. The temperature is kept at ≤75° C. using a water bath. After the sixth portion 19.4 g of dibutyl phosphite (0.1 mol) are filled into the wash bottle and the remaining paraformaldehyde adhering to the walls is washed into the four-necked flask. After the addition, the reaction mixture is stirred at 75° C. for a total of 4 hours. After cooling and the solution and from the mixture distillate (0.9 grams) is removed on a rotary evaporator at temperatures from 60° C. increasing to 75° C. over four hours down to a final vacuum of 10 mbar. Filtering through a folded paper filter afforded a filter residue of 7.6 grams and a yield of 204 grams of a clear liquid. The OH number is 210 mg KOH/g, the acid number 1.45 mg KOH/g.

D/M=0.06

Calculated weight ratio of monomer to dimer=91:9

A5.1-3: Preparation of Dibutyl Hydroxymethylphosphonate (DBHMP) with Potassium Phosphate as Catalyst

97.4 g of dibutyl phosphite (0.5 mol), 25.03 g of tributyl phosphite (0.1 mol) and 1.36 g of potassium phosphate K₃PO₄ (6.4 mmol, 0.64 mol %) are mixed and with stirring in a 0.5 dm³ four-necked flask fitted with a reflux condenser, nitrogen blanket and thermometer heated to 70° C. Simultaneously in a PE wash bottle with a magnetic stirrer at 20° C. 31.5 g of paraformaldehyde (1.05 mol) are stirred up in 58.2 g of dibutyl phosphite (0.3 mol). The suspension is metered into the four-necked flask in six portions. The temperature is kept at ≤75° C. using a water bath. After the sixth portion 19.4 g of dibutyl phosphite (0.1 mol) are filled into the wash bottle and the remaining paraformaldehyde adhering to the walls is washed into the four-necked flask. After the addition, the reaction mixture is stirred at 75° C. for a total of 4 hours. After cooling and the solution and from the mixture distillate (5.75 grams) is removed on a rotary evaporator at temperatures from 60° C. increasing to 75° C. over four hours down to a final vacuum of 10 mbar. Filtering through a folded paper filter afforded a filter residue of 8.4 grams and a yield of 207 grams of a clear liquid. The OH number is 213 mg KOH/g, the acid number 0.48 mg KOH/g.

D/M=0.07

Calculated weight ratio of monomer to dimer=90:10

A5.1-4: Preparation of Dibutyl Hydroxymethylphosphonate with Phosphazene as Catalyst

97.4 g of dibutyl phosphite (0.5 mol), 25.03 g of tributyl phosphite (0.1 mol) and 0.1 g of phosphazene base BTPP (0.32 mmol, 0.032 mol %) are mixed and with stirring in a 0.5 dm³ four-necked flask fitted with a reflux condenser, nitrogen blanket and thermometer heated to 70° C. Simultaneously in a PE wash bottle with a magnetic stirrer at 20° C. 31.5 g of paraformaldehyde (1.05 mol) are stirred up in 58.2 g of dibutyl phosphite (0.3 mol). The suspension is metered into the four-necked flask in six portions. The temperature is kept at ≤75° C. using a water bath. After the sixth portion 19.4 g of dibutyl phosphite (0.1 mol) are filled into the wash bottle and the remaining paraformaldehyde adhering to the walls is washed into the four-necked flask. After the addition, the reaction mixture is stirred at 75° C. for a total of 4 hours. The reaction mixture is then very clear. After cooling 8.7 grams of distillate is removed from the mixture on a rotary evaporator at temperatures from 60° C. increasing to 90° C. over three hours down to a final vacuum of 10 mbar. A yield of 216.2 grams of a clear liquid remains. The OH number is 203 mg KOH/g, the acid number 1.3 mg KOH/g.

D/M=0.039

Calculated weight ratio of monomer to dimer=94:6

A5.1-5: Preparation of Dibutyl Hydroxymethylphosphonate with Diisopropylethylamine as Catalyst

33.33 mL of the batch from A5-4, 31.5 g of paraformaldehyde (1.05 mol) and 3.05 g of diisopropanolamine (23.6 mmol, 2.36 mol %) are mixed and with stirring in a 0.5 dm³ four-necked flask fitted with a reflux condenser, nitrogen blanket and thermometer heated to 50° C. A mixture of 175 g of dibutyl phosphite (0.9 mol) and 25.03 g of tributyl phosphite (0.1 mol) is metered into the four-necked flask portionwise. The temperature is kept at 50° C. using a water bath. After the addition, the mixture is stirred at 75° C. for two hours. The reaction mixture is then very clear. 14.13 grams of distillate is removed from the crude product on a rotary evaporator at temperatures from 45° C. increasing to 75° C. over three hours down to a final vacuum of 10 mbar. A yield of 245.87 grams of a clear liquid remains. The OH number is 204 mg KOH/g, the acid number 2.9 mg KOH/g.

D/M=0.054

Calculated weight ratio of monomer to dimer=92:8

### A5.1-6: Preparation of Acetylated Diethyl Hydroxymethylphosphonate

45 g of A5-5 are stirred together with 25 g of acetic anhydride in a 0.1 dm³ round-bottom flask. The reaction is initially slightly exothermic. After being left to stand overnight at room temperature, the mixture is distilled on a rotary evaporator at temperatures increasing from to 100° C. over four hours down to a final vacuum of 10 mbar. A yield of 57 grams is obtained. D/M=0.016

Calculated weight ratio of monomer to dimer=98:2.

### Production and Testing of PUR/PIR Foams

The flame spread of the PUR/PIR foams was measured by edge flaming with the small burner test according to DIN 4102-1 (May 1998) on a sample having dimensions of 18 cm×9 cm×2 cm. Heat emission was measured in accordance with ISO 5660-1 (March 2015) using the “cone calorimeter”.

Measurement of apparent density was performed according to DIN EN ISO 845 (October 2009).

Tensile tests according to DIN 53430 (September 1975) were used to determine tensile strength (σ_{Fmax}), breaking elongation (ε_{breaking}) and a measure of toughness (σ_{Fmax}*ε_{breaking}/2) on tensile bars (machined according to DIN 53430 5.1). The open-cell content of the PUR/PIR foams was measured with an Accupyk-1330 instrument on test specimens having dimensions of 5 cm×3 cm×3 cm according to DIN EN ISO 4590 (August 2003).

Based on the polyol components PUR/PIR foams were produced in the laboratory by mixing 0.3 dm³ of a reaction mixture in a paper cup. To this end the flame retardant, the foam stabilizer, catalysts and water and n-pentane as the blowing agent were added to the respective polyol component and the mixture was briefly stirred. The obtained mixture was mixed with the isocyanate and the reaction mixture was poured into a paper mold (3×3×1 dm³) and reacted therein. The exact formulations of the individual experiments are reported in the tables which follow, as are the results of the physical measurements on the samples obtained.

Table 1a shows the use of dibutyl hydroxymethylphosphonate as a flame retardant (example 3) compared to flame retardants which are representative of the prior art. The PUR/PIR foam produced with the flame retardant according to the invention from Example 3 shows a reduced flame spread and heat emission despite the lower content of flame retardant chlorine and phosphorus. In addition, the PUR/PIR foam from Example 3 exhibits improved values in the tensile test according to DIN 53430 (September 1975) and a lower open-cell content compared to comparative examples 1 and 2.

TABLE 1a

| Examples | | 1* | 2* | 3 |
|---|---|---|---|---|
| A1-1 | parts by wt. | 93 | 93 | 93 |
| A2-1 | parts by wt. | 14.2 | 14.2 | 14.2 |
| A2-2 | parts by wt. | 1.6 | 1.6 | 1.6 |
| A3-1 | parts by wt. | 0.7 | 0.7 | 0.7 |
| A3-2 | parts by wt. | 2.8 | 2.8 | 2.8 |
| A4-1 | parts by wt. | 1.9 | 1.9 | 1.9 |
| A5-1 | parts by wt. | 16.7 | | |
| A5-4 | parts by wt. | | 16.7 | |
| A5.1-1 | parts by wt. | | | 16.7 |
| B-1 | parts by wt. | 216.4 | 251.1 | 240.6 |
| Index | | 300 | 300 | 300 |
| Chlorine content (calculated) | % by | 1.6 | | |
| Phosphorus content (calculated) | % by | 0.5 | 0.8 | 0.6 |
| Phosphonate content (calculated) | mol/kg¹ | 0 | 0.26 | 0.20 |
| Properties | | | | |
| Cream time | s | 15 | 12 | 12 |
| Fiber time | s | 100 | 70 | 70 |
| Rise time | s | 100 | 70 | 70 |
| Free apparent density | kg/m³ | 30 | 33 | 33 |
| σ (Fₘₐₓ) (tensile strength) | N/mm² | 0.14 | 0.16 | 0.34 |
| ε (breaking) (breaking elongation) | % | 1.2 | 1.1 | 2.1 |
| σ (Fₘₐₓ)*ε (breaking)/2 | N/mm² | 0.85*10⁻³ | 0.83*10⁻³ | 3.59*10⁻³ |
| (indicator of toughness) | | | | |
| Open-cell content | % | 12 | 15 | 11 |
| Vertical flame spread | cm | 13 | 10 | 11 |
| Fire class | | B2 | B2 | B2 |
| Maximum average heat emission | kJ/m² | 105 | 89 | 85 |
| “MARHE” | | | | |
| Maximum heat emission | kJ/m² | 127 | 119 | 113 |
| Total heat emission | MJ/m² | 10 | 11 | 11 |
| Residue | % by | 31 | 38 | 31 |

*comparative example
¹The reported values in % by weight and mol/kg relate to the total mass of the components Al to B1 = 100% by weight

Table 1b shows that compared to butylethyl hydroxymethylphosphonate as the flame retardant the flame retardant according to the invention results in a PUR/PIR foam having improved mechanical properties.

TABLE 1b

| Example | | 4* | 5 |
|---|---|---|---|
| A1-1 | parts by wt. | 100 | 100 |
| A2-1 | parts by wt. | 15.3 | 15.3 |
| A2-2 | parts by wt. | 1.7 | 1.7 |
| A3-1 | parts by wt. | 0.8 | 0.8 |
| A3-2 | parts by wt. | 3 | 3 |
| A4-1 | parts by wt. | 2 | 2 |
| A5.1-2 | parts by wt. | 18 | |
| A5.1-3 | parts by wt. | | 18 |
| B-1 | parts by wt. | 260 | 260 |
| Index | | 300 | 300 |
| Phosphorus content (calculated) | % by | 0.5 | 0.5 |
| Phosphonate content (calculated) | mol/kg¹ | 0.16 | 0.16 |
| Properties | | | |
| Cream time | s | 12 | 12 |
| Fiber time | s | 60 | 60 |
| Rise time | s | 60 | 60 |
| Free apparent density | kg/m³ | 35 | 35 |
| σ (Fₘₐₓ) (tensile strength) | N/mm² | 0.18 | 0.20 |
| ε (breaking) (breaking elongation) | % | 5.8 | 7.3 |
| σ (Fₘₐₓ)*ε (breaking)/2 | N/mm² | 5.2*10⁻³ | 7.3*10⁻³ |
| (indicator of toughness) | | | |
| Open-cell content | % | 9 | 9 |
| Vertical flame spread | cm | 11 | 11 |
| Fire class | | B2 | B2 |
| Maximum average heat emission | kJ/m² | 93 | 99 |
| “MARHE” | | | |
| Maximum heat emission | kJ/m² | 112 | 114 |
| Total heat emission | MJ/m² | 14 | 14 |
| Residue | % by | 38 | 33 |

*comparative example
¹The reported values in % by weight and mol/kg relate to the total mass of the components Al to B1 = 100% by weight

TABLE 2

| Example | | 6 | 7 | 8 |
|---|---|---|---|---|
| A1-1 | parts by wt. | 93 | 93 | 93 |
| A4-1 | parts by wt. | 1.9 | 1.9 | 1.9 |
| A2-2 | parts by wt. | 1.6 | 1.6 | 1.6 |
| A3-1 | parts by wt. | 0.7 | 0.7 | 0.7 |
| A3-2 | parts by wt. | 2.8 | 2.8 | 2.8 |
| A2-1 | parts by wt. | 14.2 | 14.2 | 14.2 |
| A5.1-1 | parts by wt. | 16.7 | | |
| A5.1-4 | parts by wt. | | 16.7 | |
| A5.1-5 | parts by wt. | | | 16.7 |
| B-1 | parts by wt. | 242 | 241 | 241 |
| Index | | 300 | 300 | 300 |
| Phosphorus content | % by | 0.6 | 0.6 | 0.6 |
| Phosphonate content | mol/kg¹ | 0.20 | 0.20 | 0.20 |
| Properties | | | | |
| Cream time | s | 13 | 15 | 14 |
| Fiber time | s | 33 | 35 | 38 |
| Rise time | s | 55 | 55 | 60 |
| Cream time/rise time | % | 39 | 43 | 37 |
| Free apparent density | kg/m³ | 34 | 35 | 35 |
| Open-cell content | % | 13 | 12 | 13 |
| Vertical flame spread | cm | 12 | 12 | 12 |
| Fire class | | B2 | B2 | B2 |

¹The reported values in % by weight and mol/kg relate to the total mass of the components A1 to B1 = 100% by weight

Table 2 shows the comparison of the PUR/PIR foams of examples 6 to 8 which according to the invention contain a component A5.1 as a flame retardant. The components A5.1 in table 2 were prepared with a phosphorus-containing base (examples 6 and 6) or an amine (example 8) as catalyst. The PUR/PIR foams of examples 6 to 8 have the same vertical flame spread. However, the PUR/PIR foams of examples 6 and 7 produced according to a preferred embodiment show more advantageous kinetics which are characterized by the higher cream time/rise time ratio.

TABLE 3

| Examples | | 9* | 10* |
|---|---|---|---|
| A1-2 | parts by wt. | 67.7 | 67.7 |
| A2-1 | parts by wt. | 14.6 | 13.4 |
| A3-2 | parts by wt. | 1.9 | 2.8 |
| A4-1 | parts by wt. | 3.8 | 3.8 |
| A5-2 | parts by wt. | 9.5 | 9.5 |
| A5-5 | parts by wt. | 14.3 | |
| A5.1-6 | parts by wt. | | 14.3 |
| B1 (Desmodur 44V70L) | parts by wt. | 118 | 96 |
| Index | | 320 | 320 |
| Phosphorus content (calculated) | % by weight¹ | 1.6 | 1.5 |
| Phosphonate content (calculated) | mol/kg¹ | 0.31 | 0.31 |
| Properties | | | |
| Cream time | s | 11 | 13 |
| Fiber time | s | 35 | 67 |
| Rise time | s | 60 | 95 |
| Apparent density | kg/m³ | 34 | 32 |
| Vertical flame spread | cm | 11 | 9 |
| MARHE | kJ/m² | 101 | 97 |
| Maximum heat emission | kJ/m² | 123 | 127 |
| Total heat emission | MJ/m² | 11 | 9 |
| Residue | % by weight | 46 | 45 |

*comparative example
¹The reported values in % by weight and mol/kg relate to the total mass of the components A1 to B1 = 100% by weight

The results of tables 3 and 4 show that when using acetylated diethyl hydroxymethylphosphonate as component A5 (examples 10, 12 and 13) good flame retardancy is obtained.

TABLE 4

| Example | | 11* | 12* | 13* |
|---|---|---|---|---|
| A1-3 | parts by | 86 | 84.3 | 83.9 |
| A5-3 | parts by | 7.7 | | |
| A5.1-6 | parts by | | 9.4 | 9.8 |
| A4-1 | parts by | 2 | 2 | 2 |
| A2-2 | parts by | 0.8 | 0.8 | 0.8 |
| A2-3 | parts by | 16.7 | 16.7 | 17.4 |
| A3-2 | parts by | 2.7 | 2.7 | 2.7 |
| A3-1 | parts by | 0.8 | 0.8 | 0.8 |
| Desmodur ® 44V20L, | parts by | 200 | 200 | 210.5 |
| Index | | 300 | 304 | 321 |
| Phosphorus content (calculated) | % by | 0.5 | 0.5 | 0.5 |
| Phosphonate content (calculated) | mol/kg¹ | 0.15 | 0.15 | 0.15 |
| Properties | | | | |
| Cream time | s | 11 | 10 | 11 |
| Fiber time | s | 35 | 40 | 43 |
| Tack-free time | s | 51 | 60 | 66 |
| Apparent density | kg/m³ | 30.6 | 29.5 | 29.6 |
| Adhesion to paper after 5 mm² | | 5 | 3 | 3 |
| Adhesion to paper after 24 h² | | 4 | 3 | 3 |
| Vertical flame spread | cm | 18 | 17 | 16 |

*comparative example
¹The reported values in % by weight and mol/kg are based on the total mass of the components A1 to B1 = 100% by weight
²Adhesion to paper is assessed according to German school grades by an employee trained therefor.

1. A process for producing PUR/PIR foams by reaction of a reaction mixture containing
A1 an isocyanate-reactive component
A2 blowing agent
A3 catalyst
A4 optionally additive
A5 flame retardant
with
B an isocyanate component,
wherein production is carried out at an index of 80 to 600,
wherein the flame retardant A5 contains as component A5.1 dibutyl hydroxymethylphosphonate and optionally its dimer.

2. The process as claimed in claim 1, wherein the isocyanate-reactive component A1 contains a polyester polyol.

3. The process as claimed in claim 2, wherein the polyester polyol has an OH number in the range from 100 to 400 mg KOH/g.

4. The process as claimed in claim 1, wherein the blowing agent A2 is selected from one or more compounds from the group consisting of halogen-free chemical blowing agents, halogen-free physical blowing agents and (hydro)fluorinated olefins.

5. The process as claimed in claim 1, wherein the flame retardant A5 contains 30.0% by weight to 100.0% by weight, based on the total mass of the flame retardant A5, of the component A5.1.

6. The process as claimed in claim 1, wherein the proportion of the component A5.1 is 0.1% by weight to 30.0% by weight based on the total mass of the component A1=100% by weight.

7. The process as claimed in claim 1, wherein the flame retardant A5 contains no halogen-containing flame retardant.

8. The process as claimed in claim 1, wherein the component A5.1 has been produced using a catalyst selected from at least one compound from the group consisting of phosphorus-containing bases, alkali metal carbonates and amines, with the exception of tertiary trialkylamines.

9. The process as claimed in claim 1, wherein the component A5.1 has been produced using a phosphorus-containing base as catalyst.

10. The process as claimed in claim 1, wherein the component A5.1 has been produced in the absence of tertiary amines and without phosphorus-free solvents.

11. The process as claimed in claim 1, wherein the component A5.1 is a mixture of dibutyl hydroxymethylphosphonate and 0.1% to 30% by weight of a dimer of the dibutyl hydroxymethylphosphonate based on the total weight of the employed dibutyl hydroxymethylphosphonate.

12. The process as claimed in claim 1, wherein the reaction mixture contains
A1 50% by weight to 100% by weight of one or more polyester polyols and 0% by weight to 20% by weight of one or more polyether polyols, in each case based on the total weight of the component A1,
A2 water and physical blowing agents,
A3 catalyst,
A4 optionally additive,
A5 flame retardant containing A5.1 dibutylhydroxymethylphosphonate and optionally its dimer,
is reacted with
B polymeric isocyanate.

13. The process as claimed in claim 1, wherein the reaction mixture contains
A1 a polyester polyol having a hydroxyl number of 50 mg KOH/g to 400 mg KOH/g,
A2 blowing agent containing a compound selected from the group consisting of halogen-free chemical blowing agents, halogen-free physical blowing agents and (hydro)fluorinated olefins,
A3 catalyst containing alkali metal carboxylate and/or di- or trialkylaminomethylphenol,
A4 additive containing a foam stabilizer,
A5 flame retardant containing A5.1 dibutylhydroxymethylphosphonate and optionally its dimer,
with
B monomeric and polymeric MDI.

14. A PUR/PIR foam obtainable by the process as claimed in claim 1.

15. A method comprising producing an insulation material with the PUR/PIR foam as claimed in claim 14.

16. The process as claimed in claim 1, wherein component A5.1 contains dibutyl hydroxymethylphosphonate and its dimer.

17. The process as claimed in claim 1, wherein the reaction mixture further contains the additive.

18. The process as claimed in claim 6, wherein the proportion of the component A5.1 is 0.1% by weight to 30.0% by weight based on the total mass of the component A1=100% by weight and 0.04-0.4 mol of phosphonate per kg of foam.

19. The process as claimed in claim 12, wherein the reaction mixture further contains the additive.

20. The process as claimed in claim 12, wherein the component A5.1 contains dibutyl hydroxymethylphosphonate and its dimer.
